(19) United States
(12) Patent Application Publication
(10) Pub. No.: US 2008/0219454 A1
(43) Pub. Date: Sep. 11, 2008

(54) Sound Image Localization Apparatus

(75) Inventors: Kazuhiro Iida, Kanagawa (JP); Gempo Ito, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Kadoma-shi, Osaka (JP)

(21) Appl. No.: 11/722,586

(22) PCT Filed: Aug. 30, 2005
(86) PCT No.: PCT/JP05/15724

§ 371 Date: Jun. 22, 2007

(30) Foreign Application Priority Data
Dec. 24, 2004 (JP) 2004-373883
Jun. 1, 2005 (JP) 2005-161602

(51) Int. Cl. H04R 5/00

(52) U.S. Cl. 381/17

(57) ABSTRACT

It is an object of the present invention to provide a sound image localization apparatus which can provide a sound image localized in a targeted spot with accuracy for each listener, and reduce the amount of data and calculations needed to localize the sound image in the targeted spot with accuracy. The parameter setting unit 11 has parameters (center frequency “fc”, sharpness “Q”, and signal level “L”) needed to reproduce structural features selected from among peaks, dips, and attenuations in high and low frequency ranges, and other structural features of amplitude-frequency characteristics of the head-related transfer function corresponding to respective spots, and parameters (delay time and signal level) needed to reproduce structural features such as interaural time difference (ITD) and interaural level difference (ILD) of the standard head-related transfer functions corresponding to respective spots. The parameter setting unit 11 sets parameters of a targeted spot to the sound image localization processing unit 12, while the sound image localization processing unit 12 processes a sound source signal on the basis of the parameters from the parameter setting unit 11, and outputs sound image localization signals.

### TECHNICAL FIELD OF THE INVENTION

The present invention relates to a sound image localization apparatus for processing a sound source signal to ensure that a sound image is accurately localized in a targeted spot in three-dimensional space.

### DESCRIPTION OF THE RELATED ART

Up until now, there have been researched a wide variety of technologies related to an apparatus for processing sound source signals to ensure that a sound image is accurately localized in a targeted spot in three-dimensional space by using a sound reproducing apparatus such as for example a loudspeaker or a headphone.

The above-mentioned technologies disclose that a sound image is accurately localized in a targeted spot under the condition that acoustic transfer characteristics between a targeted spot and listener's ears are accurately reproduced, and sounds are reproduced from the sound source signals convolved with the acoustic transfer characteristics.

Here, the acoustic transfer characteristics includes a spatial transfer function to be characterized by reflection, diffraction, and scattering resulting from walls and the like, and a head-related transfer function to be characterized by reflection, diffraction, and scattering resulting from listener's head or body.

It is well known that a sound image is accurately localized in a targeted spot under the condition that a head-related transfer function of a listener is accurately reproduced, sounds to be received by the listener are reproduced from sound source signals convolved with the head-related transfer function (see, for example, a patent document 1).

As an example of the conventional sound image localization apparatus, there has been known an apparatus for localizing a sound image in a targeted spot under the condition that the head-related transfer function of each listener is accurately measured, sounds to be received by each listener are reproduced from sound source signals convolved with the measured head-related transfer function. As another example of conventional sound image localization apparatus, there has been known an apparatus for localizing a sound image in a targeted spot under the condition that sounds to be received by each listener are reproduced from sound source signals convolved with the standard head-related transfer function.

FIG. 14 is a block diagram showing the conventional sound image localization apparatus.

As shown in FIG. 14, the conventional sound image localization apparatus comprises a head-related transfer function storing unit 61 for storing, as filter coefficients to be set to finite impulse response filter (hereinafter simply referred to as “FIR filter”), head-related transfer functions corresponding to respective directions, a head-related transfer function selecting unit 62 for selecting one of the head-related transfer functions on the basis of position information indicative of a targeted spot, and a sound image localization processing unit 63 for processing sound source signal on the basis of the selected head-related transfer function.

Here, the head-related transfer function storing unit 61 may store either the head-related transfer functions of each listener or the standard head-related transfer functions.

In the above-mentioned sound image localization apparatus, an inputted sound source signal is convolved with the head-related transfer function selected on the basis of inputted position information, and then outputted to a sound reproducing apparatus such as a headphone unit and a loudspeaker unit as a sound image localization signal.

From the foregoing description, it will be understood that the conventional sound image localization apparatus can localize the sound image in the targeted spot by using the head-related transfer function of each listener, or the standard head-related transfer function.

The above-mentioned sound image localization apparatus, however, encounters such a problem that it is necessary to store data of the head-related transfer functions corresponding to respective spots. The data require large amount of storage. Further, the large amount of calculations to be performed by FIR filters prevents the sound image localization apparatus from being improved in construction, and in size.

In order to solve the above-mentioned problems, the conventional device has parameters (center frequency “fc”, sharpness “Q”, and signal level “L”) to be selectively set to an infinite impulse response filter (hereinafter simply referred to as “IIR filter”). The conventional sound image localization apparatus is adapted to reproduce a standard head-related transfer function corresponding to a targeted spot by setting a parameter corresponding to the targeted spot to the IIR filter (see, for example, a patent document 1).

It is well known that the sound image tends to fail to be localized at the targeted spot under the condition that the sounds are reproduced on the basis of the head-related transfer function of someone else. Accordingly, the above-mentioned sound image localization apparatus tends to fail to localize the sound image at the targeted spot by using the standard head-related transfer function.

It is, in practice, impossible to measure all of the head-related transfer functions corresponding to respective listeners without using special measurement equipment or the like. As a result, it is not easy to have the conventional sound image localization apparatus localize the sound image to the targeted spot by using the head-related transfer function of the listeners.

In order to solve the above-mentioned problems, there has been provided a sound image localization apparatus for optimizing head-related transfer function for each listener by expanding or compressing standard head-related transfer function on a frequency axis (see patent document 2).

patent document 1: Japanese published unexamined application No.: 2000-23299 patent document 2: Japanese published unexamined application No.: 2001-16697 non-patent document 1: “Spatial Hearing” written by Jens Blauert, MIT PRESS, 1983.

### DISCLOSURE OF THE INVENTION

### Problems to be Solved by the Invention

As a result of the fact that the sound image localization apparatus disclosed in the patent document 1 reproduces only one structural feature selected from among peaks and dips of the amplitude-frequency characteristics of the head-related transfer function by using only one IIR filter, the conventional sound image localization apparatus tends to fail to localize a sound image in the targeted spot. Even if the conventional sound image localization apparatus reproduces the structural features of the head-related transfer function by using a plurality of IIR filters, the conventional sound image localization apparatus cannot reduce the amount of data and calculations necessary to reproduce the structural features of the head-related transfer function with accuracy.

The sound image localization apparatus disclosed in patent document 2 tends to fail to customize the standard head-related transfer function for each listener, and to localize the sound image in the targeted spot with accuracy by reason that the standard head-related transfer function is expanded or compressed on a frequency axis if necessary, the expanded or compressed head-related transfer function being used as the head-related transfer function customized for each listener.

It is, therefore, an object of the present invention to provide a sound image localization apparatus which can provide a sound image localized in a targeted spot with ease and accuracy for each listener, and reduce the amount of data and calculations to be needed to reproduce the structural features of the head-related transfer function.

### Means for Solving the Problems

The sound image localization apparatus is adapted to process a sound source signal to reproduce one or more structural features of a head-related transfer function with respect to a targeted spot from the processed sound source signal.

The sound image localization apparatus thus constructed as previously mentioned can localize the sound image in the targeted spot with ease and accuracy by reproducing the structural features of the head-related transfer function, and reduce the amount of data and calculations to be needed to localize the sound image in the targeted spot.

The sound image localization apparatus according to the present invention may comprise parameter setting means for setting a parameter corresponding to the structural features of the head-related transfer function with respect to the targeted spot, and sound image localization processing means for processing the sound source signal on the basis of the parameter set by the parameter setting means, and outputting the processed sound source signal as a sound image localization signal.

The sound image localization apparatus thus constructed as previously mentioned can perform a sound image localization operation, and localize the sound image in the targeted spot with ease and accuracy by using a parameter prepared for the reproduction of the structural features of the head-related transfer function.

In the sound image localization apparatus according to the present invention, the parameter setting means may be adapted to set, on the basis of inputted listener information, the parameter to the sound image localization processing means.

The sound image localization apparatus thus constructed as previously mentioned can provide the sound image localized in the targeted spot with accuracy for each listener by setting a parameter on the basis of the inputted listener information.

In the sound image localization apparatus according to the present invention, the listener information may include physical feature information indicative of one or more physical features of a listener.

The sound image localization apparatus thus constructed as previously mentioned can provide the sound image localized in the targeted spot with accuracy for each listener by setting a parameter on the basis of the physical feature information indicative of one or more physical features of a listener.

The sound image localization apparatus according to the present invention may further comprise physical feature information obtaining means for obtaining the physical feature information from the listener information, and outputting the physical feature information to the parameter setting means.

The sound image localization apparatus thus constructed as previously mentioned can provide the sound image localized in the targeted spot with accuracy for each listener by obtaining the physical feature information from the listener information, and by setting a parameter on the basis of the obtained physical feature information.

In the sound image localization apparatus according to the present invention, the physical feature information obtained from the listener information may include an image indicative of the physical features of the listener.

The sound image localization apparatus thus constructed as previously mentioned can provide the sound image localized in the targeted spot with accuracy for each listener by obtaining the physical feature information from the listener information, and by setting a parameter on the basis of the obtained physical feature information.

In the sound image localization apparatus according to the present invention, the listener information may include a head-related transfer function measured or calculated in relation to a listener.

The sound image localization apparatus thus constructed as previously mentioned can provide the sound image localized in the targeted spot with accuracy for each listener by setting a parameter on the basis of the head-related transfer function of each listener.

In the sound image localization apparatus according to the present invention, the listener information may include one or more attributes of the listener.

The sound image localization apparatus thus constructed as previously mentioned can provide the sound image localized in the targeted spot with accuracy for each listener by setting a parameter on the basis of the attributes of the listener.

In the sound image localization apparatus according to the present invention, the listener information may include one or more audiologic features of a listener.

The sound image localization apparatus thus constructed as previously mentioned can provide the sound image localized in the targeted spot with accuracy for each listener by setting a parameter on the basis of the audiologic features of the listener.

In the sound image localization apparatus according to the present invention, the parameter setting means may have a function of the parameter to the targeted spot. The parameter setting means may be adapted to calculate the parameter from the targeted spot by using the function of the parameter to the targeted spot.

The sound image localization apparatus thus constructed as previously mentioned can reduce the amount of data and calculations to be needed for the reproduction of the structural features of the head-related transfer function by setting a parameter corresponding to the targeted spot with ease.

In the sound image localization apparatus according to the present invention, the parameter setting means may have a table of the parameter to the targeted spot. The parameter setting means may be adapted to obtain the parameter from the targeted spot by using the table of the parameter to the targeted spot.

The sound image localization apparatus thus constructed as previously mentioned can reduce the amount of data and calculations to be needed for the reproduction of the structural features of the head-related transfer function by setting a parameter corresponding to the targeted spot with ease.

In the sound image localization apparatus according to the present invention, the parameter setting means may have a function of the parameter to the targeted spot and the listener information. The parameter setting means may be adapted to calculate the parameter from the targeted spot and the listener information by using the function of the parameter to the targeted spot and the listener information.

The sound image localization apparatus thus constructed as previously mentioned can reduce the amount of data and calculations to be needed for the reproduction of the structural features of the head-related transfer function by setting a parameter corresponding to the targeted spot with ease.

In the sound image localization apparatus according to the present invention, the parameter setting means may have a table of the parameter to the targeted spot and the listener information. The parameter setting means may be adapted to obtain the parameter from the targeted spot and the listener information by using the table of the parameter to the targeted spot and the listener information.

The sound image localization apparatus thus constructed as previously mentioned can reduce the amount of data and calculations to be needed for the reproduction of the structural features of the head-related transfer function by setting a parameter corresponding to the targeted spot with ease.

In the sound image localization apparatus according to the present invention, the parameter setting means may be adapted to estimate a parameter corresponding to a targeted spot by using two or more parameters of positions adjacent to the targeted spot when the judgment is made that the table fails to include the parameter corresponding to the targeted spot.

The sound image localization apparatus thus constructed as previously mentioned can reduce the amount of data to be needed for the reproduction of the structural features of the head-related transfer function.

In the sound image localization apparatus according to the present invention, the parameter setting means may be adapted to set a parameter corresponding to one or more structural features selected from among peaks, dips, and attenuations in high and low frequency ranges of amplitude-frequency characteristics of the head-related transfer function.

The sound image localization apparatus thus constructed as previously mentioned can provide the sound image localized in the targeted spot with accuracy for each listener by reproducing one or more structural features selected from among peaks, dips, and attenuations in high and low frequency ranges of amplitude-frequency characteristics of the head-related transfer function, and reduce the amount of data and calculations to be needed for the reproduction of the structural features of the head-related transfer function.

In the sound image localization apparatus according to the present invention, the parameter setting means may be adapted to set a parameter needed to reproduce either an interaural time difference of the head-related transfer function or an interaural level difference of the head-related transfer function, or both the interaural time difference and the interaural level difference.

The sound image localization apparatus thus constructed as previously mentioned can provide the sound image localized in the targeted spot with accuracy for each listener by reproducing either an interaural time difference of the head-related transfer function or an interaural level difference of the head-related transfer function, or both the interaural time difference and the interaural level difference, and reduce the amount of data and calculations to be needed for the reproduction of the structural features of the head-related transfer function.

In the sound image localization apparatus according to the present invention, the sound image localization processing means may include a plurality of infinite impulse response filters. The parameter setting means may be adapted to set the parameter needed to reproduce one or more structural features selected from among the peaks, dips, and attenuations in high and low frequency ranges to each of the infinite impulse response filters.

The sound image localization apparatus thus constructed as previously mentioned can reduce the amount of data and calculations to be needed for the reproduction of the structural features of the head-related transfer function.

In the sound image localization apparatus according to the present invention, the sound image localization processing means may include either a delay unit or a level controller, or both the delay unit and the level controller. The parameter setting means may be adapted to set the parameter needed to reproduce the interaural time difference to the delay unit, and to set the parameter needed to reproduce the interaural time difference to the level controller.

The sound image localization apparatus thus constructed as previously mentioned can reduce the amount of data and calculations to be needed for the reproduction of the structural features of the head-related transfer function.

The sound image localization apparatus according to the present invention may be adapted to reproduce the structural features of the head-related transfer function of one of listener's ears by using the structural features of the head-related transfer function, of the other of the listener's ears, of a position symmetrically related to the targeted spot.

The sound image localization apparatus thus constructed as previously mentioned can reduce the amount of data to be needed for the reproduction of the structural features of the head-related transfer function.

The sound image localization apparatus according to the present invention may be adapted to change the number of the structural features of the head-related transfer function to be reproduced.

The sound image localization apparatus thus constructed as previously mentioned can reduce the amount of data and calculations to be needed for the reproduction of the structural features of the head-related transfer function.

The sound image localization apparatus according to the present invention may be adapted to change the number of the structural features of the head-related transfer function to be reproduced on the basis of data processing capacity assigned as being needed to localize a sound image to the targeted spot.

The sound image localization apparatus thus constructed as previously mentioned can reduce the amount of data and calculations to be needed for the reproduction of the structural features of the head-related transfer function.

The sound image localization apparatus according to the present invention may be adapted to change the number of the structural features of the head-related transfer function to be reproduced in relation to each position.

The sound image localization apparatus thus constructed as previously mentioned can reduce the amount of data and calculations to be needed for the reproduction of the structural features of the head-related transfer function.

The sound image localization apparatus according to the present invention may be adapted to change the number of the structural features of the head-related transfer function to be reproduced in relation to each listener.

The sound image localization apparatus thus constructed as previously mentioned can reduce the amount of data and calculations to be needed for the reproduction of the structural features of the head-related transfer function.

The program is of allowing a computer to function as parameter setting means for setting at least one parameter selected from among a parameter corresponding to one or more structural features selected from among peaks, dips, and attenuations in high and low frequency ranges of amplitude-frequency characteristics of a head-related transfer function of a targeted spot, a parameter needed to reproduce an interaural time difference of the head-related transfer function, and a parameter needed to reproduce an interaural level difference of the head-related transfer function, and to function as sound image localization processing means for processing a sound source signal on the basis of the selected parameter to produce a sound image localization signal from the sound source signal, and outputting the sound image localization signal.

The program thus constructed as previously mentioned can provide the sound image localized in the targeted spot with accuracy for each listener by reproducing one or more structural features selected from among peaks, dips, and attenuations in high and low frequency ranges of amplitude-frequency characteristics of the head-related transfer function, an interaural time difference of the head-related transfer function, and an interaural level difference of the head-related transfer function, and provide a sound image localized in a targeted spot with ease and accuracy for each listener, and reduce the amount of data and calculations to be needed for the reproduction of the structural features of the head-related transfer function.

### ADVANTAGEOUS EFFECT OF THE INVENTION

The sound image localization apparatus according to the present invention can reduce the amount of data and calculations to be needed for the reproduction of the structural features of the head-related transfer function by reproducing structural features selected from among peaks, dips, and attenuations in high and low frequency ranges of amplitude-frequency characteristics of the head-related transfer function, an interaural time difference of the head-related transfer function, and an interaural level difference of the head-related transfer function, and provide a sound image localized in a targeted spot with ease and accuracy for each listener.

### BRIEF DESCRIPTION OF THE DRAWINGS

FIG. 1 is a block diagram showing the first embodiment of the sound image localization apparatus according to the present invention.

FIG. 2 is a view for explaining the amplitude-frequency characteristics of the head-related transfer function.

FIG. 3 is a view for explaining the interaural time difference and interaural level difference of the head-related transfer function.

FIG. 4 is a block diagram showing the sound image localization processing unit of the sound image localization apparatus according to the first embodiment of the present invention.

FIG. 5 is a view for explaining another method of replicating peaks and dips of the frequency characteristics in the sound image localization apparatus according to the first embodiment of the present invention.

FIG. 6 is a block diagram showing the parameter setting unit of the sound image localization apparatus according to the first embodiment of the present invention, the parameter setting unit being adapted to set a parameter by using a parameter setting function.

FIG. 7 is a block diagram showing the parameter setting unit of the sound image localization apparatus according to the first embodiment of the present invention, the parameter setting unit being adapted to set a parameter by using a parameter table.

FIG. 8 is a block diagram showing the second embodiment of the sound image localization apparatus according to the present invention.

FIG. 9 is a block diagram showing the parameter setting unit of the sound image localization apparatus according to the second embodiment of the present invention, the parameter setting unit being adapted to set a parameter by using a parameter setting function.

FIG. 10 is a block diagram showing the parameter setting unit of the sound image localization apparatus according to the second embodiment of the present invention, the parameter setting unit being adapted to set a parameter by using a parameter table.

FIG. 11 is a block diagram showing the third embodiment of the sound image localization apparatus according to the present invention.

FIG. 12 is a block diagram showing the physical feature extracting unit of the sound image localization apparatus according to the third embodiment of the present invention.

FIG. 13 is a view for explaining the bilateral symmetry of the head-related transfer function.

FIG. 14 is a block diagram showing the conventional sound image localization apparatus.

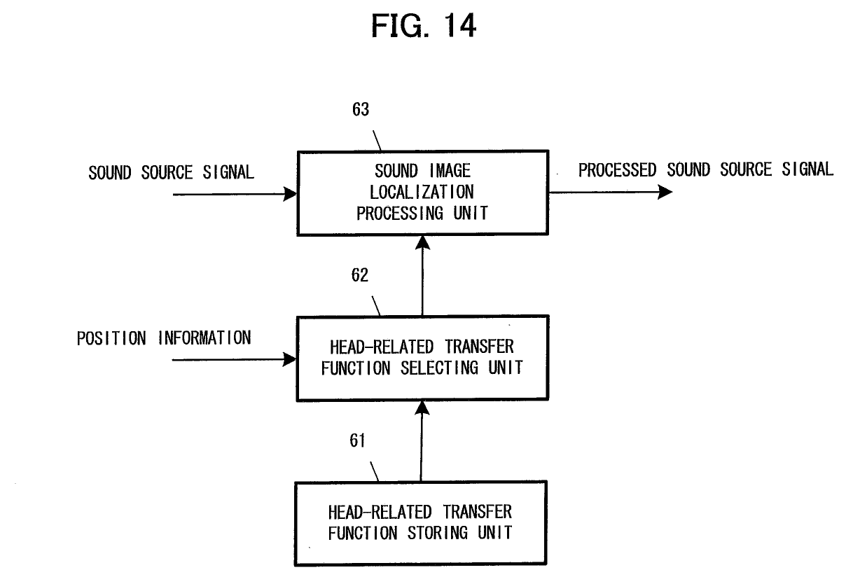

### EXPLANATION OF THE REFERENCE NUMERALS

11: parameter setting unit
111: parameter calculating unit
112: parameter selecting unit
12: sound image localization processing unit
121La to 121Lz and 121Ra to 121Rz: left and right channel IIR filters
112L and 122R: left and right channel delay unit
123L and 123R: left and right channel level controller
21: parameter setting unit
221: parameter calculating unit
212: parameter selecting unit
31: physical feature extracting unit
311: image processing unit
61: head-related transfer function storing unit
62: head-related transfer function selecting unit
63: sound image localization processing unit

### DETAILED DESCRIPTION OF THE PREFERRED EMBODIMENT

The following description will be firstly directed to a theory regarding structural features of a head-related transfer function, this structural feature having a clue for solving a problem on whether or not the sound image is localized in a targeted spot.

As mentioned in the prior art, those skilled in the art know, on the basis of experiences showing that the sound image is localized in the targeted spot when the head-related transfer function is reproduced with accuracy, that the head-related transfer function have a clue for solving a problem on whether or not the sound image is localized in a targeted spot.

The above-mentioned non-patent document 1 discloses that structural features such as for example a peak, a dip, and an attenuation pattern in high or low frequency range of the amplitude-frequency characteristics of the head-related transfer function has a clue for solving a problem on how the sound image is localized in vertical and front-back directions. On the other hand, interaural time difference (ITD), interaural level difference (ILD), and the like contained in the structural features of the head-related transfer function has a clue for solving a problem on how the sound image is localized in right-left direction.

As a result of analysis by inventors on the structural feature of the head-related transfer function to each listener, we have found that the sound image is accurately localized at the targeted spot under the condition that, for example, five or six structural features selected from among the structural features (such as for example a peak, a dip, an attenuation pattern in high frequency range, or in low frequency range) of the head-related transfer function is reproduced. It is not essential to reproduce all of the structural features of the head-related transfer function.

Further, we have found that the sound image is accurately localized in the targeted spot under the condition that the structural features similar to each other, without being differ in individuals, are selectively reproduced.

It is well known that the conventional device can control the sound image in right-left direction by using the interaural time difference (ITD) and the interaural level difference (ILD) without affecting the sound image controlled in vertical and front-back directions (see, for example, U.S. Pat. No. 3,388,235). Accordingly, the sound image can be controlled in right-left direction on the basis of the interaural time difference (ITD) and the interaural level difference (ILD) after the structural features having a clue for solving a problem on how the sound image is localized in vertical and front-back directions are reproduced.

The first to third embodiments of the sound image localization apparatus according to the present invention will be described hereinafter with reference to the accompanying drawings.

### First Embodiment

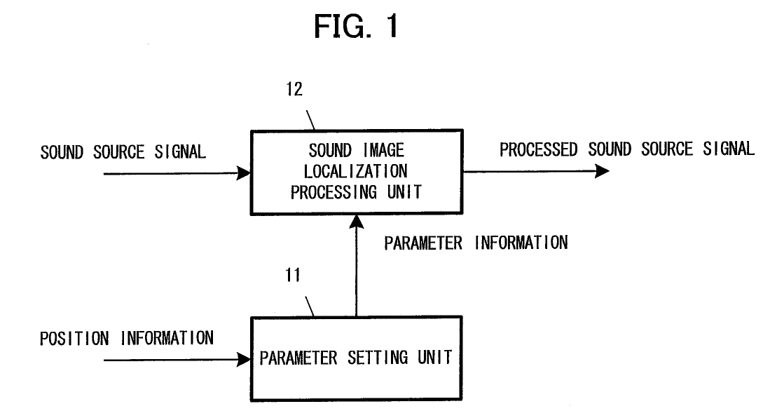

FIG. 1 is a block diagram showing the first embodiment of the sound image localization apparatus according to the present invention.

The sound image localization apparatus is shown in FIG. 1 as comprising a parameter setting unit 11 and a sound image localization processing unit 12. The parameter setting unit 11 has a parameter needed to replicate a structural feature of a head-related transfer function to a targeted spot. The parameter setting unit 11 is adapted to set the parameter to the sound image localization processing unit 12, while the sound image localization processing unit 12 is adapted to process an inputted sound source signal on the basis of the parameter set by the parameter setting unit 11, and to output the processed sound source signal to an audio reproducing device (not shown) such as for example a microphone unit and a loudspeaker unit.

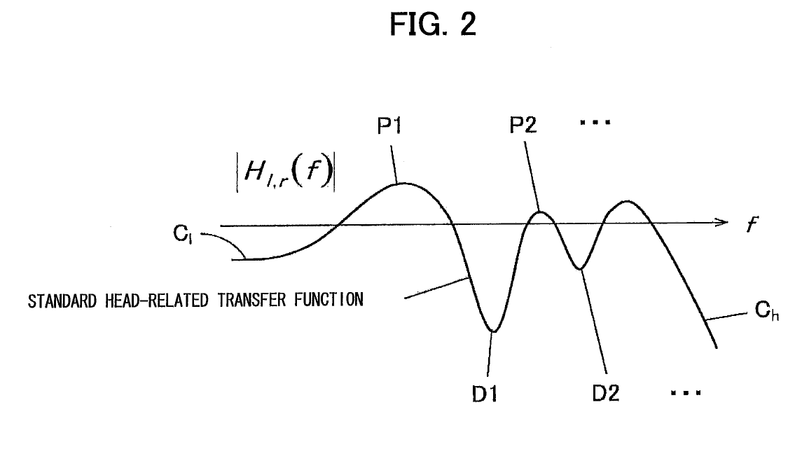

As shown in FIG. 2, the parameter setting unit 11 is adapted to set parameters (center frequency “fc”, sharpness “Q”, and signal level “L”) needed to reproduce two or more structural features selected from among structural features (such as for example peaks “P1”, “P2”, . . . , dips “D1”, “D2”, . . . , an attenuation pattern “Ch” in high frequency range, and an attenuation pattern “Cl” in low frequency range) of the amplitude-frequency characteristics |Hl,r(f)| of the standard head-related transfer function to the targeted spot.

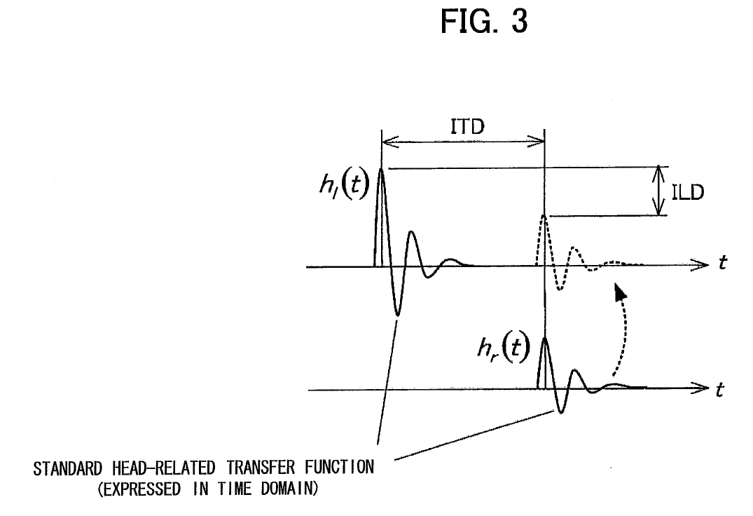

As shown in FIG. 3, the parameter setting unit 11 is adapted to set parameters (delay time and signal level) needed to reproduce structural features such as an interaural time difference “ITD” and an interaural level difference “ILD” between standard head-related transfer functions “hl(t)” and “hr(t)” corresponding to each ear.

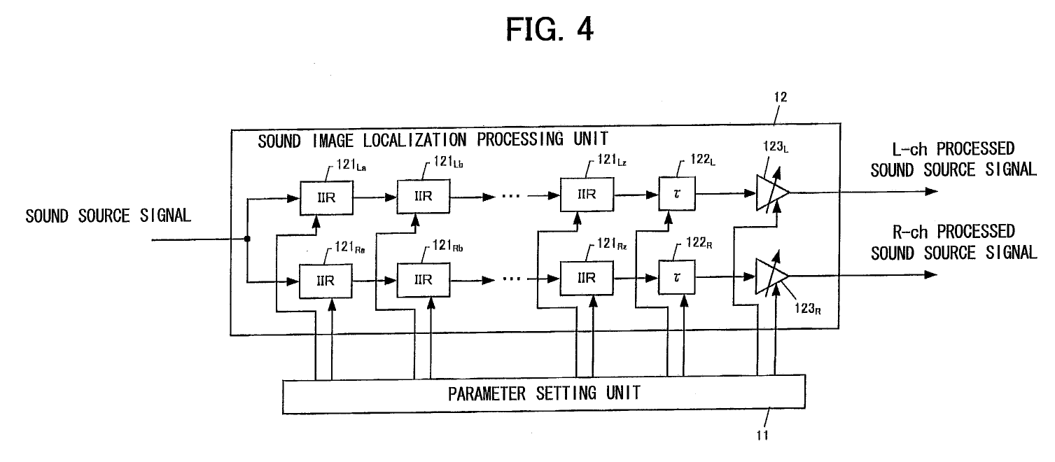

As shown in FIG. 4, the sound image localization processing unit 12 includes a plurality of left channel IIR filters 121La to 121Lz for processing the sound source signal on the basis of the parameters (center frequency “fc”, sharpness “Q”, and signal level “L”) needed to reproduce two or more structural features selected from among structural features (such as for example peaks “P1”, “P2”, . . . , dips “D1”, “D2”, . . . , an attenuation pattern “Ch” in high frequency range, and an attenuation pattern “Cl” in low frequency range) of the amplitude-frequency characteristics |Hl(f)| of the standard head-related transfer function to each targeted spot, a plurality of right channel IIR filters 121Ra to 121Rz for processing the sound source signal on the basis of the parameters (center frequency “fe”, sharpness “Q”, and signal level “L”) needed to reproduce two or more structural features selected from among structural features (such as for example peaks “P1”, “P2”, . . . , dips “D1”, “D2”, . . . , an attenuation pattern “Ch” in high frequency range, and an attenuation pattern “Cl” in low frequency range) of the amplitude-frequency characteristics |Hr(f)| of the standard head-related transfer function to each targeted spot, right and left channel delay units 122R and 122L for delaying the sound source signals received from the right and left channel IIR filters 121Rz and 121Lz on the basis of the parameters (for defining each delay time) set by the parameter setting unit 11, and right and left channel level controllers 123R and 123L for controlling in signal level the sound source signal received from the right and left channel delay units 122R and 122L on the basis of the parameters (for defining each signal level) set by the parameter setting unit 11.

When the information on a position to be occupied by a sound image is inputted to the parameter setting unit 11 forming part of the sound image localization apparatus thus constructed as previously mentioned, the parameter setting unit 11 is adapted to set right channel parameters (center frequency “fc”, sharpness “Q”, and signal level “L” needed to reproduce two or more structural features selected from among structural features of the amplitude-frequency characteristics |Hr(f)| of the standard head-related transfer function to the targeted spot) to the right channel IIR filters 121Ra to 121Rz, and to set left channel parameters (center frequency “fe”, sharpness “Q”, and signal level “L” needed to reproduce two or more structural features selected from among structural features of the amplitude-frequency characteristics |Hl(f)| of the standard head-related transfer function to the targeted spot) to the left channel IIR filters 121La to 121Lz.

The parameter setting unit 11 is adapted to set a right channel parameter (for defining a delay time corresponding to the right channel) to the right channel delay unit 122R, to set a left channel parameter (for defining a delay time corresponding to the left channel) to the left channel delay unit 122L, to set a right channel parameter (for defining a signal level corresponding to the right channel) to the right channel level controller 123R, and to set a left channel parameter (for defining a signal level corresponding to the left channel) to the left channel level controller 123L.

In the sound image localization processing unit 12, the left channel IIR filters 121La to 121Lz are adapted to process a sound source signal received as a left channel signal on the basis of the left channel parameters set by the parameter setting unit 11. The right channel IIR filters 121Ra to 121Rz are adapted to process a sound source signal received as a right channel signal on the basis of the right channel parameters set by the parameter setting unit 11. The left channel delay unit 122L is adapted to delay the sound source signal processed by the left channel IIR filters 121La to 121Lz on the basis of the left channel parameter set by the parameter setting unit 11, while the right channel delay unit 122R is adapted to delay the sound source signal processed by the right channel IIR filters 121Ra to 121Rz on the basis of the right channel parameter set by the parameter setting unit 11. The left channel level controller 123L is adapted to control in signal level the sound source signal to be outputted as a left channel sound image localization signal on the basis of the parameter set by the left channel parameter setting unit 11, while the right channel level controller 123R is adapted to control in signal level the sound source signal to be outputted as a right channel sound image localization signal on the basis of the right channel parameter set by the parameter setting unit 11.

From the foregoing description, it will be understood that the sound image localization apparatus according to the first embodiment of the present invention can reduce the amount of data and calculation needed to reproduce the head-related transfer function to a targeted spot without deteriorating a sound image to be localized to the targeted spot, and allow each listener to listen a sound produced from the processed sound source signal with the sound image localized to the targeted spot.

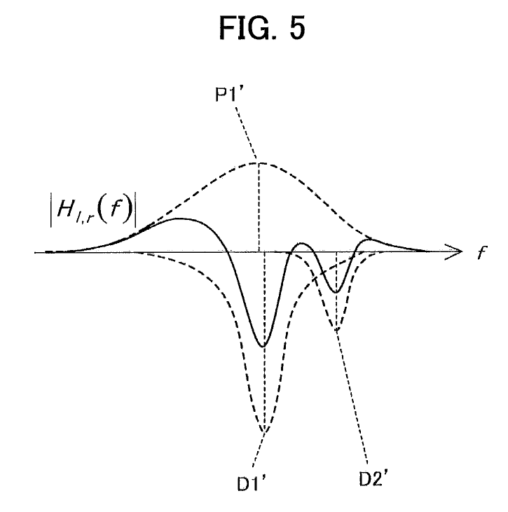

In this embodiment, each of the IIR filters is adapted to process the sound source signal on the basis of a parameter to reproduce one peak or one dip of the amplitude-frequency characteristics |Hl,r(f)| of the head-related transfer function of the targeted spot. However, as shown in FIG. 5, three peaks and two dips may be synthesized with one peak P1′ reproduced by one IIR filter and two dips D1′ and D2′ reproduced by two IIR filters. In other words, the sound image localization apparatus according to the first embodiment can reduce the number of the IIR filters by reason that five structural features (peaks and dips) are synthesized by one peak P1′ and two dips D1′ and D2′ reproduced by three IIR filters. Even if the number of the IIR filters is smaller than the number of the selected structural features, the combined IIR filters can reproduce the selected structural features of the head-related transfer function.

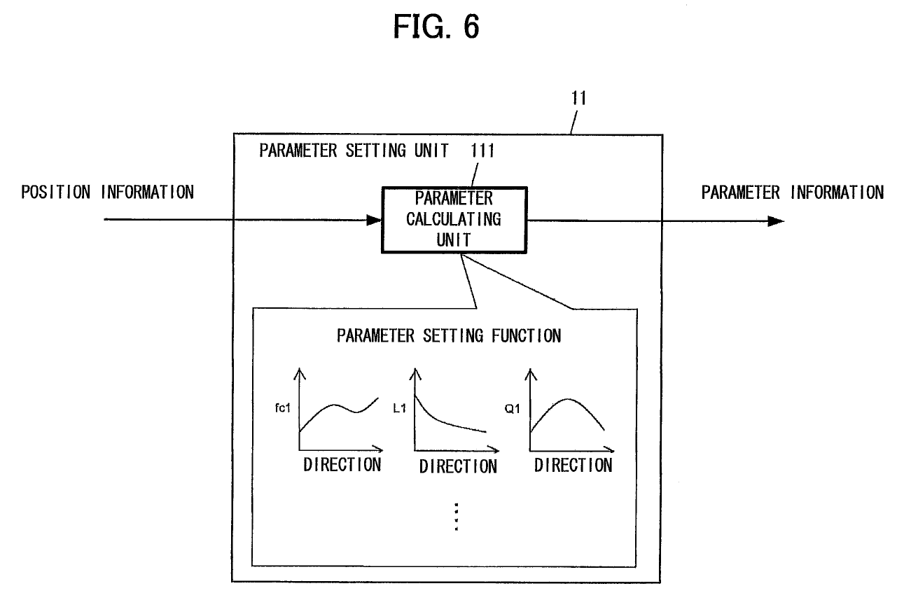

As shown in FIG. 6, the parameter setting unit 11 may have a parameter calculating unit 111 having one or more functions of the parameter to the inputted position information. In this case, the parameter calculating means 111 may be adapted to calculate the parameter from the inputted position information on the basis of the functions of the parameter to the inputted position information.

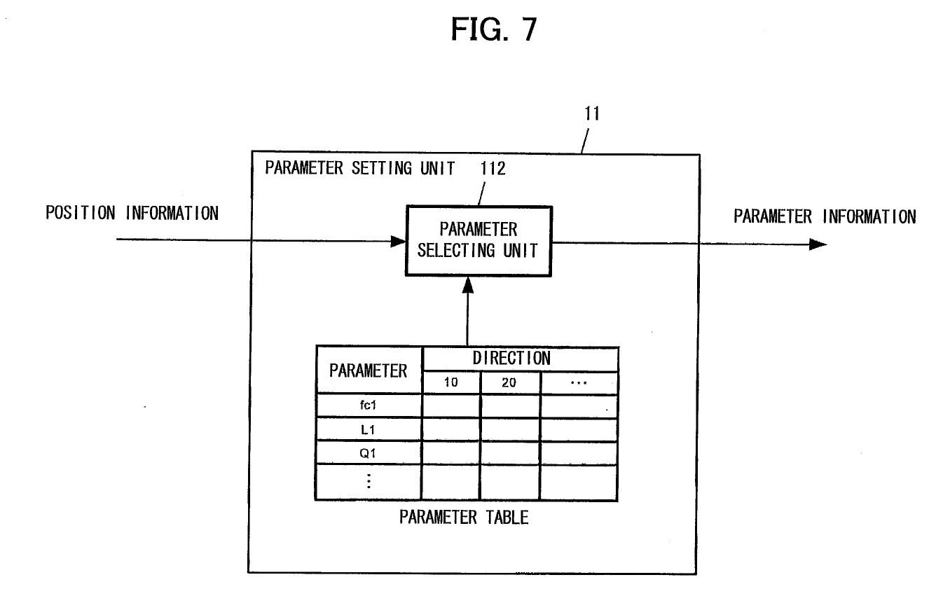

As shown in FIG. 7, the parameter setting unit 11 may have a parameter selecting unit 112 having a table of the parameter to the inputted position information stored therein. In this case, the parameter selecting unit 112 may be adapted to obtain the parameter related to the inputted position information by using the table of the parameter to the inputted position information. Additionally, the parameter selecting unit 112 may be adapted to calculate a parameter related to the inputted position information from one or more parameters related to positions close to a targeted spot represented by the inputted position information through conventional interpolation method (for example, linear interpolation) when the judgment is made that the table does not include the parameter related to the inputted position information.

### Second Embodiment

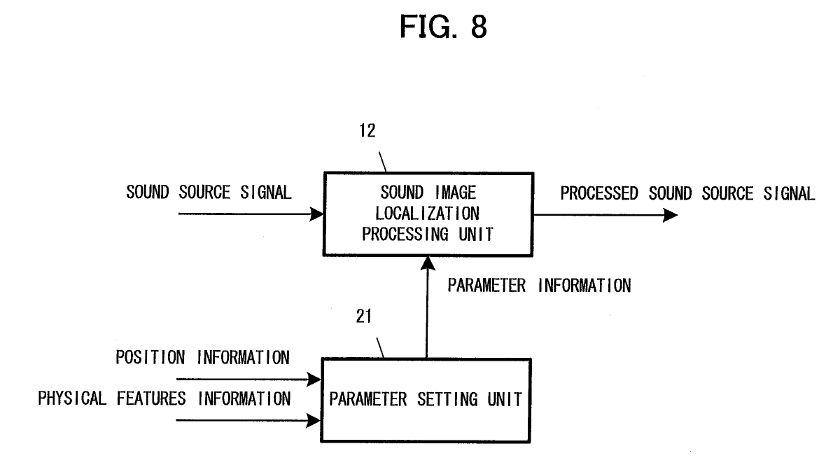

The second embodiment of the sound image localization apparatus according to the present invention will be described hereinafter with reference to FIG. 8. The constitution elements of the sound image localization apparatus according to the second embodiment are almost the same as those of the sound image localization apparatus according to the first embodiment. Therefore, the constitution elements of the sound image localization apparatus according to the second embodiment the same as those of the sound image localization apparatus according to the first embodiment will not be described but bear the same reference numbers as those of the sound image localization apparatus according to the first embodiment.

In the sound image localization apparatus according to the second embodiment, the parameter setting unit 21 is adapted to obtain not only position information about a spot which a sound image is localized in, but also physical feature information about a physical feature such as for example size and shape of listener's head and ears, those physical features having an relatively large influence on the sound image to be localized in a targeted spot, to determine a parameter on the basis of the position information and the physical feature information, and to set the parameter to the sound image localization processing unit 12.

More specifically, the parameter setting unit 21 has parameters (center frequency “fc”, sharpness “Q”, and signal level “L”) needed to reproduce two or more structural features (such as peak, dip, and attenuation in low frequency range or high frequency range) of amplitude-frequency characteristics |Hl,r(f)| of the head-related transfer function to each physical feature (such as for example the size and shape of listener's pinnae or cavum conchae), and targeted spot to be occupied by the sound image.

The parameter setting unit 21 has parameters (such as delay time and signal level) to be needed to reproduce one or more structural features (such as interaural time difference (ITD) and interaural level difference (ILD)) of the head-related transfer function (left ear: hl(t), right ear: hr(t)) to each physical feature such as for example the size of listener's head defined between right and left ears, and to each targeted spot.

When the parameter setting unit 21 receives the position information and the physical feature information (such as for example size or shape of pinnae of listener's ears, listener's head, and the like), the parameter setting unit 21 determines parameters (center frequency “fc”, sharpness “Q”, and signal level “L”) on the basis of the position information and the physical feature information, the number of the determined parameter depending on the number of the selected structural features of the head-related transfer function, sets a parameter for left ear to the left IIR filters 121La to 121Lz, and sets a parameter for right to the right filters 121Ra to 121Rz.

The parameter setting unit 21 sets, to the left channel delay unit 122L, left channel delay time corresponding to the inputted position information, the size of listener's head, and the like, sets, to the right channel delay unit 122R, right channel delay time corresponding to the inputted position information, the size of listener's head, and the like, sets, to the left channel level controller 123L, left channel signal level corresponding to the inputted position information, the size of listener's head, and the like, and sets, to the right channel level controller 123R, right channel signal level corresponding to the inputted position information, the size of listener's head, and the like.

In the sound image localization processing unit 12, the right and left channel signals produced from the sound source signal processed on the basis of the parameters set by the parameter setting unit 21 by the left channel IIR filters 121La to 121Lz, the right channel IIR filters 121Ra to 121Rz, the left channel delay unit 122L, the right channel delay unit 122R, the left channel level controller 123L, and the right channel level controller 123R. The left and right channel sound image localization signals are outputted from the sound image localization processing unit 12.

From the foregoing description, it will be understood that the sound image localization apparatus according to the second embodiment of the present invention can reduce the amount of data and calculations to be needed for the reproduction of the structural features of the head-related transfer function, and provide the sound image localized in the targeted spot with accuracy for each listener by reproducing one or more structural features selected from among peaks, dips, and attenuations in high and low frequency ranges of amplitude-frequency characteristics of the head-related transfer function.

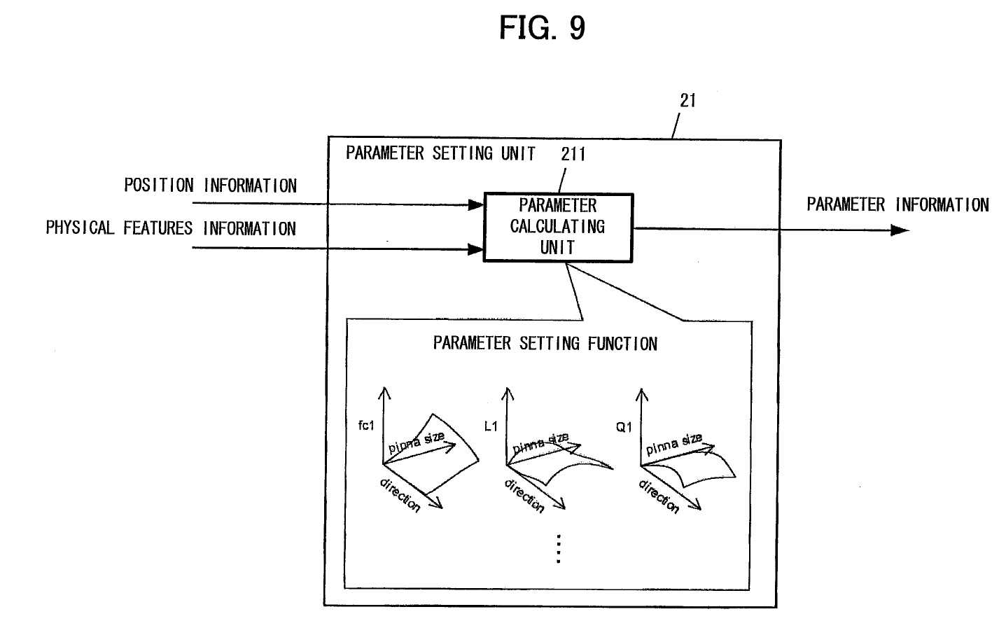

As shown in FIG. 9, the parameter setting unit 21 may have a parameter calculating unit 211 having one or more functions of the parameter to the inputted position information and the physical feature information. In this case, the parameter calculating means 211 may be adapted to calculate the parameter from the inputted position information and the physical feature information on the basis of the functions of the parameter to the inputted position information and the physical feature information.

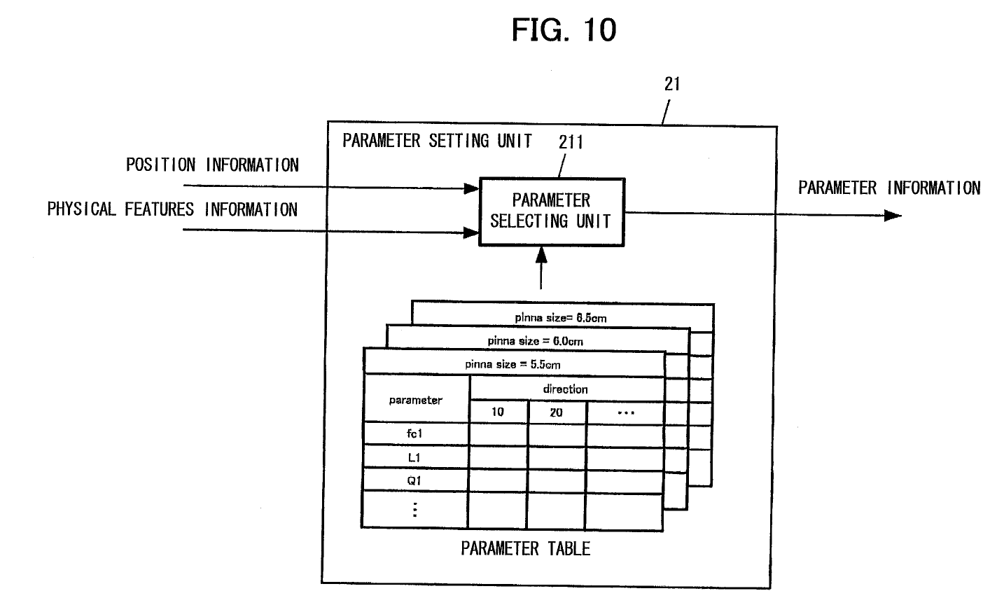

As shown in FIG. 10, the parameter setting unit 21 may have a parameter selecting unit 212 having a table of the parameter to the inputted position information and the physical feature information stored therein. In this case, the parameter selecting unit 112 may be adapted to obtain the parameter related to the inputted position information and the physical feature information by using the table of the parameter to the inputted position information and the physical feature information. Additionally, the parameter selecting unit 112 may be adapted to calculate a parameter related to the inputted position information and the physical feature information from one or more parameters related to positions close to a targeted spot represented by the inputted position information and the physical feature information through conventional interpolation method (for example, linear interpolation) when the judgment is made that the table does not include the parameter related to the inputted position information and the physical feature information.

In this embodiment, the parameter setting means is adapted to set a parameter on the basis of the physical feature information. However, the parameter setting means may be adapted to set a parameter to the sound image localization processing unit 12 on the basis of a measured or an estimated head-related transfer function corresponding to the listener. In this case, the parameter setting means may extract peaks, dips, and attenuations in high and low frequency ranges, ITD, and ILD of the head-related transfer function of the listener, and set parameters on the basis of the extracted structural features. The parameter setting means may set parameters on the basis of gender, age, and other attributes of the listener. The parameter setting means may set parameters on the basis of directional bands, hearing acuity, or other aural characteristics as disclosed in the non-patent document 1.

### Third Embodiment

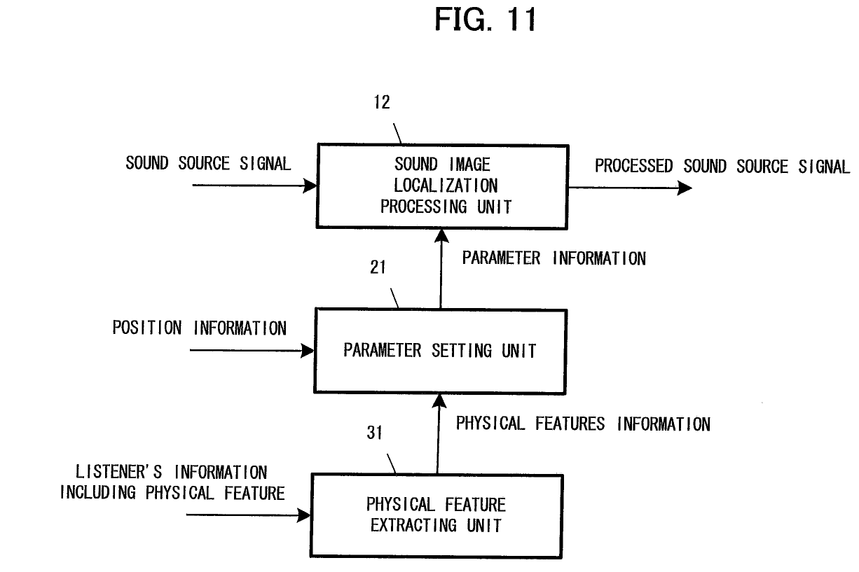

The third embodiment of the sound image localization apparatus according to the present invention will be then described hereinafter with reference to FIG. 11. The constitutional elements of the sound image localization apparatus according to the third embodiment is almost the same as those of the sound image localization apparatus according to the second embodiment. Therefore, the constitutional elements of the sound image localization apparatus according to the third embodiment the same as those of the sound image localization apparatus according to the second embodiment will not be described but bear the same reference numbers as those of the sound image localization apparatus according to the second embodiment.

The sound image localization apparatus according to the third embodiment comprises a physical feature extracting unit 31 for obtaining the physical feature information from the inputted listener information, and outputting the extracted physical feature information to the parameter setting unit 21. The parameter setting unit 21 is adapted to set a parameter to be outputted to the sound image localization processing unit 12 on the basis of the position information and the physical feature information.

The parameter setting unit 21 is the same in construction as that of the second embodiment, and has parameters (such as center frequency “fc”, sharpness “Q”, and level “L”) corresponding to two or more structural features (such as peak, dip, and attenuation in low frequency range or high frequency range) of amplitude-frequency characteristics |Hl,r(f)| of the head-related transfer function to each physical feature (such as for example size and shape of listener's pinnae or cavum conchae), and targeted spot to be occupied by the sound image.

The parameter setting unit 21 has parameters (such as delay time and signal level) needed to reproduce one or more structural features (such as interaural time difference (ITD) and interaural level difference (ILD)) of the head-related transfer function (left ear: hl(t), right ear: hr(t)) to each physical feature such as for example the size of listener's head defined between right and left ears, and to each targeted spot.

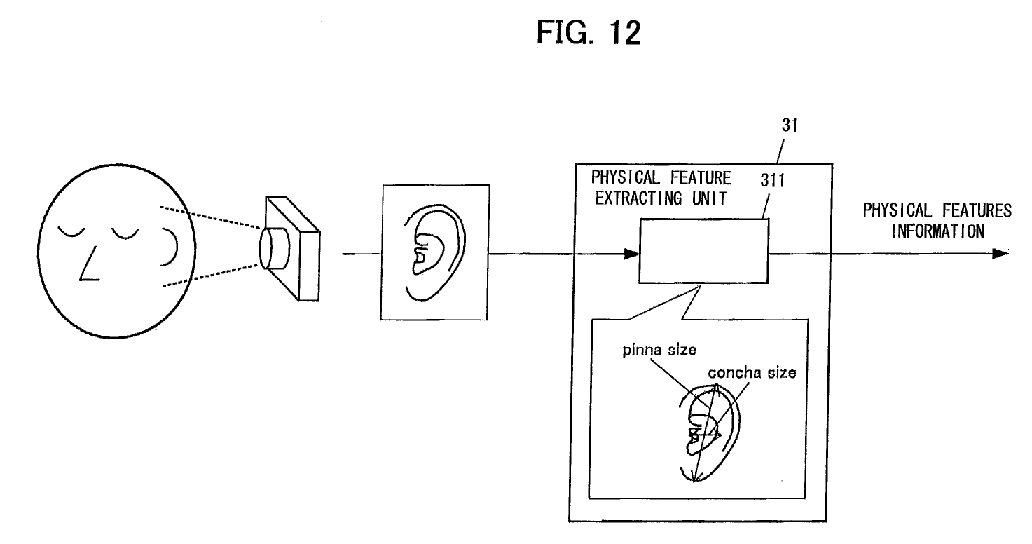

As shown in FIG. 12, the images of listener's ears, head, and the like taken by a camera is inputted into the physical feature extracting unit 31.

The size of each ear, the shape of each auricle, and other physical feature information is then extracted from the inputted images by the image recognition unit 311 on the basis of feature extraction, pattern matching, or other method. The extracted physical feature information is then inputted into the parameter setting unit 21.

The right and left channel parameters (center frequency “fc”, sharpness “Q”, and signal level “L”) are read out on the basis of the targeted spot, the size of each ear, the shape of each auricle, and other physical features from the physical feature extracting unit 31. The left channel parameters are respectively set to the left channel IIR filters 121La to 121Lz by the parameter setting unit 21, while the right channel parameters are respectively set to the right channel IIR filters 121Ra to 121Rz by the parameter setting unit 21.

The right channel delay time corresponding to the targeted spot and the size of listener's head and the like is set to the right channel delay unit 122R, while the left channel delay time corresponding to the targeted spot and the size of listener's head and the like is set to the left channel delay unit 122L. The right channel level corresponding to the targeted spot and the size of listener's head and the like is set to the right channel level controller 123R, while the left channel level corresponding to the targeted spot and the size of listener's head and the like is set to the left channel level controller 123L.

In the sound image localization processing unit 12, the sound source signal is divided into right and left channel sound source signals. The right channel (R-ch) sound source signal is processed by the IIR filters 121Ra to 121Rz, the delay unit 122R, and the level controller 123R on the basis of the parameter set by the parameter setting unit 21, while the left channel (L-ch) sound source signal is processed by the IIR filters 121La to 121Lz, the delay unit 122L, and the level controller 123L on the basis of the parameter set by the parameter setting unit 21. The processed right channel sound source signal is outputted as a right channel (R-ch) sound image localization signal from the sound image localization processing unit 12, while the processed left channel (L-ch) sound source signal is outputted as a left channel (L-ch) sound image localization signal from the sound image localization processing unit 12.

From the foregoing description, it will be understood that the sound image localization apparatus according to the third embodiment can provide a sound image localized in a targeted spot with accuracy for each listener, and reduce the amount of data and calculations to be needed for the reproduction of the structural features of the head-related transfer function by extracting physical features of each listener from image and the like, and reproducing one or more structural features selected from among peaks, dips, and attenuations in high and low frequency ranges of amplitude-frequency characteristics of the head-related transfer function corresponding to the extracted physical features and the targeted spot.

In each embodiment described above, when, for example, the targeted spot is on a median plane, i.e., it is only necessary to control the sound image in vertical and front-back directions, the parameter setting unit does not set parameters corresponding to the interaural time difference (ITD) and the interaural level difference (ILD). The sound image localization processing unit processes the sound source signals by using the IIR filters without using the delay units and the level controllers.

When, for example, the targeted spot is on a horizontal plane, i.e., it is only necessary to control the sound image in right-left direction, the parameter setting unit does not set parameters corresponding to one or more structural features selected from among peaks, dips, and attenuations in high and low frequency ranges of amplitude-frequency characteristics of said head-related transfer function. The sound image localization processing unit processes the sound source signals, without using the IIR filters, by using the delay units and the level controllers.

When, for example, the targeted spot is in the vicinity of the median plane, the amplitude-frequency characteristics of the head-related transfer functions corresponding to the respective ears, and the targeted spot are similar to each other. Therefore, the sound image localization processing unit may process the sound source signal, without having the left and right channel IIR filters process the respective signals, by having either the left and right channel IIR filters process the sound source signal. The sound image localization apparatus thus constructed can obtain the same advantageous effects.

The listener can obtain the clue of sound image localization from either the interaural time difference (ITD) or the interaural level difference (ILD). Therefore, the sound image localization processing unit may have either delay units or level controllers, while the parameter setting unit may set either the interaural time difference (ITD) or the interaural level difference (ILD) to either the delay unit or the level controller of the sound image localization processing unit. The sound image localization apparatus thus constructed can obtain the same advantageous effects.

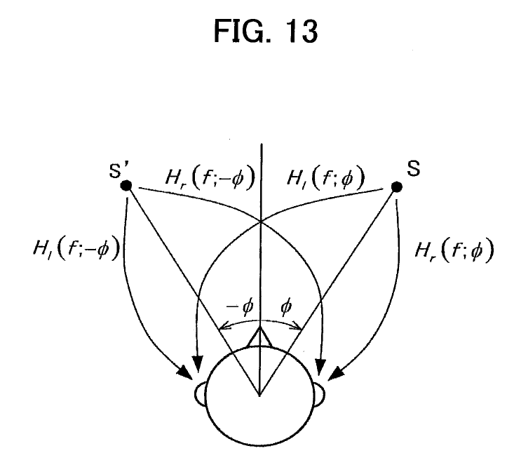

In general, human's head is substantially symmetrical. As shown in, for example, FIG. 13, the structural features of the right channel head-related transfer function Hr(f; φ) of a spot are substantially the same as the structural features of the left channel head-related transfer function Hl(f, −φ) of a spot symmetrical to that spot. Similarly, the structural features of the left channel head-related transfer function Hl(f; φ) of a spot are substantially the same as the structural features of the right channel head-related transfer function Hr(f; −φ) of a spot symmetrical to that spot.

Therefore, the sound image localization apparatus according to the present invention may have, for example, information on the structural features of the head-related transfer functions of respective spots defined only in the right side of the space, and may be adapted to reproduce the structural features of the head-related transfer function corresponding to one of each listener's ears and a targeted spot defended in the left side of the space, by using the structural features of the head-related transfer functions corresponding to the other of each listener's ears and a spot symmetrically related to the targeted spot (as shown in FIG. 13, by using structural features of Hr(f; −φ) and Hl(f; −φ) corresponding to a spot φ as structural features of Hl(f; φ) and Hr(f; φ), respectively). The sound image localization apparatus according to the present invention can obtain the above-mentioned advantageous effects when using the structural features of the head-related transfer function corresponding to the other of the listener's ears, and a spot symmetrically related to the targeted spot.

The sound image localization apparatus according to the present invention may have, for example, information on the structural features of the head-related transfer functions corresponding to only right ear of each listener, and may be adapted to reproduce the structural features of the head-related transfer function corresponding to left ear of each listener by using the structural features of the head-related transfer function corresponding to right ear of each listener and a spot symmetrically related to the targeted spot (as shown in FIG. 13, by using structural features of Hr(f; −φ) of a spot as structural features of Hl(f; φ)). The sound image localization apparatus according to the present invention can obtain the above-mentioned advantageous effects when using the structural features of the head-related transfer function corresponding to the other of the listener's ears, and a spot symmetrically related to the targeted spot.

In either case, the sound image localization apparatus according to the present invention can localize the sound image at the targeted spot with accuracy without being affected by asymmetrical components of the head-related transfer function in comparison with the conventional method (see, for example, Japanese published unexamined application No.: H07-111699) in which the head-related transfer function is directly used as symmetric function, and reduce the account of data and calculation to be needed to localize the sound image in the targeted spot, by using, as symmetric feature, the selected structural features of the head-related transfer function.

The number of the structural features of the head-related transfer function needed to localizing a sound image in a targeted spot may be manually or automatically changed on the basis of a direction of a sound image to be localized, listener, or processing capacity assigned to a sound image localization operation.

Even if processing capacity assigned to a sound image localization operation is reduced, the sound image localization apparatus according to the present invention can prevent a sound image from deteriorating further by reproducing structural features selected as being especially significant for the sound image localization by using the reduced capacity.

In these embodiments, the sound image localization apparatus is adapted to perform a sound image localization operation by using the IIR filters, the delay units, and the level controllers. However, the sound image localization apparatus may be constituted by a digital signal processor (DSP) or the like for performing the above-mentioned operation by executing a program.

The parameter setting unit and the physical feature extracting unit may collectively constitute an assist device for setting parameters needed to localize a sound image in a targeted spot, or a sound image localization information server for providing an external device, by performing communication with the external device, with parameters needed to localize the sound image in the targeted spot. On the other hand, the sound image localization processing unit may be constituted as a sound source signal processing device for performing a sound image localization operation on the basis of parameters needed to localize the sound image in the targeted spot.

When sounds represented by the sound image localization signals are reproduced by loudspeaker units or the like, the sound image localization apparatus according to each embodiment may be provided with a crosstalk canceller for performing a crosstalk canceling operation to reproduce sounds through the loudspeaker units or the like.

### INDUSTRIAL APPLICABILITY OF THE PRESENT INVENTION

As will be seen from the foregoing description, the sound image localization apparatus according to the present invention has advantageous effects of providing a sound image localized in a targeted spot with accuracy for each listener, and reducing the amount of data and calculation needed to localize the sound image in the targeted spot. The sound image localization apparatus according to the present invention is useful as cellar phone, sound reproducing device, sound recording device, data processing device, game machine, conference system, communication system, broadcasting system, and other apparatus for performing a sound image localization operation while performing sound reproduction and the like.

1-20. (canceled)

21-24. (canceled)

25. A sound image localization apparatus for processing a sound source signal to localize a sound image in a targeted spot, comprising:
a parameter setting unit operable to set at least one parameter needed to reproduce one or more structural features selected from among structural features of a head-related transfer function to said targeted spot; and
a sound image localization processing unit operable to process said sound source signal on the basis of said parameter set by said parameter setting unit, and to output said processed sound source signal as a sound image localization signal, wherein
said structural features includes at least one of peak, dip, attenuation in high frequency range, attenuation in low frequency range, interaural time difference between right and left ears, and interaural level difference between right and left ears.

26. A sound image localization apparatus according to claim 1, wherein
said structural features includes at least one peak in low frequency range and two dips in high frequency range,
said parameter setting unit sets a parameter needed to reproduce two dips in said high frequency range.

27. A sound image localization apparatus according to claim 2, wherein
said parameter setting unit sets a parameter needed to reproduce structural features of two dips in said high frequency range and one peak in said low frequency range.

28. A sound image localization apparatus according to claim 2, wherein
said structural features further includes either an interaural time difference of said head-related transfer function or an interaural level difference of said head-related transfer function, or both said interaural time difference and said interaural level difference, and
said parameter setting unit sets a parameter needed to reproduce either said interaural time difference or said interaural level difference, or both said interaural time difference and said interaural level difference.

29. A sound image localization apparatus according to claim 1, wherein said parameter setting unit sets a parameter corresponding to listener information.

30. A sound image localization apparatus according to claim 1, wherein said parameter setting unit has a function of said parameter to said targeted spot, and calculates said parameter from said targeted spot by using said function of said parameter to said targeted spot.

31. A sound image localization apparatus according to claim 1, wherein said parameter setting unit has a parameter table of said parameter to said targeted spot, and obtains said parameter from said targeted spot by using said parameter table of said parameter to said targeted spot.

32. A sound image localization apparatus according to claim 5, wherein said parameter setting unit has a function of said parameter to said targeted spot and said listener information, and calculates said parameter from said targeted spot and said listener information by using said function of said parameter to said targeted spot and said listener information.

33. A sound image localization apparatus according to claim 5, wherein said parameter setting unit has a parameter table of said parameter to said targeted spot and said listener information, and obtains said parameter from said targeted spot and said listener information by using said parameter table of said parameter to said targeted spot and said listener information.

34. A sound image localization apparatus according to claim 7 or claim 9, wherein said parameter setting unit estimates a parameter corresponding to a targeted spot by using two or more parameters of positions adjacent to said targeted spot when the judgment is made that said parameter table fails to include said parameter corresponding to said targeted spot.

35. A sound image localization apparatus according to claim 1, wherein said sound image localization processing unit includes a least one infinite impulse response filter, and
said parameter setting unit sets said parameter needed to reproduce one or more structural features selected from among said peaks, dips, and attenuations in high and low frequency ranges to said infinite impulse response filter.

36. A sound image localization apparatus according to claim 11, wherein
said sound image localization processing unit includes infinite impulse response filters for reproducing two dips in said high frequency range,
said parameter setting unit sets said parameter needed to reproduce said two dips in said high frequency range to said infinite impulse response filters.

37. A sound image localization apparatus according to claim 12, wherein
said sound image localization processing unit includes an infinite impulse response filter needed to reproduce one peak in said low frequency range,
said parameter setting unit sets said parameter needed to reproduce said one peak in said low frequency range to said infinite impulse response filters.

38. A sound image localization apparatus according to claim 1, wherein
said sound image localization processing unit includes either a delay unit or a level controller, or both said delay unit and said level controller, and
said parameter setting unit sets said parameter needed to reproduce said interaural time difference to said delay unit, and to set said parameter needed to reproduce said interaural time difference to said level controller.

39. A sound image localization apparatus according to claim 1, wherein said parameter setting unit reproduces said structural features of said head-related transfer function of one of listener's ears by using said structural features of said head-related transfer function, of the other of said listener's ears, of a spot symmetrically related to said targeted spot.

40. A sound image localization apparatus according to claim 1, wherein said parameter setting unit changes the number of said structural features of said head-related transfer function on the basis of data processing capacity assigned as being needed to localize a sound image in said targeted spot.

41. A sound image localization apparatus according to claim 1, wherein said parameter setting unit changes the number of said structural features of said head-related transfer function in relation to each spot.

42. A sound image localization apparatus according to claim 1, wherein said parameter setting unit changes the number of said structural features of said head-related transfer function in relation to each listener.

43. A sound image localization apparatus according to claim 5, wherein said listener information includes physical feature information indicating one or more physical features of a listener.

44. A sound image localization apparatus according to claim 19, further comprising:
a physical feature information obtaining unit operable to obtain said physical feature information from said listener information, and to output said physical feature information to said parameter setting unit.

45. A sound image localization apparatus according to claim 20, wherein said listener information includes an image indicating said physical features of said listener.

46. A sound image localization apparatus according to claim 5, wherein said listener information includes a head-related transfer function measured or calculated in relation to a listener.

47. A sound image localization apparatus according to claim 5, wherein said listener information includes one or more attributes of said listener.

48. A sound image localization apparatus according to claim 5, wherein said listener information includes one or more audiologic features of a listener.

49. A program for allowing a computer to function as a parameter setting unit operable to set at least one parameter selected from among a parameter corresponding to one or more structural features selected from among peaks, dips, and attenuations in high and low frequency ranges of amplitude-frequency characteristics of a head-related transfer function of a targeted spot, a parameter needed to reproduce an interaural time difference of said head-related transfer function, and a parameter needed to reproduce an interaural level difference of said head-related transfer function, and to function as a sound image localization processing unit operable to process a sound source signal on the basis of said selected parameter to produce a sound image localization signal from said sound source signal, and to output said sound image localization signal.

50. A program according to claim 25, wherein said parameter includes a parameter needed to reproduce at least two dips in said high frequency range of said head-related transfer function.
